(19) United States
(12) Patent Application Publication
(10) Pub. No.: US 2012/0083934 A1
(43) Pub. Date: Apr. 5, 2012

(54) MONITORING AND CONTROLLING ENERGY IN AN OFFICE ENVIRONMENT

(75) Inventors: Basil Isaiah Jesudason, Portland, OR (US); Craig Thompson Whittle, Vancouver, WA (US); Mary Louise Bourret, Portland, OR (US); Andrew Rodney Ferlitsch, Camas, WA (US)

(73) Assignee: Sharp Laboratories of America, Inc., Camas, WA (US)

(21) Appl. No.: 12/895,422

(22) Filed: Sep. 30, 2010

(51) Int. Cl. G06F 1/26

(52) U.S. Cl. 700/291

(57) ABSTRACT

A method for monitoring and controlling energy usage in an office environment is described. Energy usage information and sensor data are received from a status and control unit for an appliance. An appropriate energy profile for the appliance is determined. The energy profile is customizable by an end user based on preferences and schedules. The energy profile corresponds to appliances within an energy group. A control message is sent to the status and control unit to implement the determined energy profile.

### TECHNICAL FIELD

The present invention relates generally to electronic devices and computer-related technology. More specifically, the present invention relates to systems and methods for monitoring and controlling energy in an office environment.

### BACKGROUND

Historically, energy monitoring and control systems have been the purview of companies that manage heating, ventilating and air conditioning (HVAC) systems and utility companies that deliver power. Many building owners pass along utility costs to their tenants. These tenants have little control or visibility of their energy usage. Thus, benefits may be realized by providing improved systems and methods for controlling energy usage.

### BRIEF DESCRIPTION OF THE DRAWINGS

FIG. 1 illustrates an exemplary operating environment in which the disclosed systems and methods for monitoring and controlling energy in an office environment may be utilized;

FIG. 2 is a block diagram illustrating a controlling module for use in the present systems and methods;

FIG. 3 is a block diagram illustrating an energy controlling device;

FIG. 4 is a flow diagram of a method for monitoring/controlling energy usage;

FIG. 5 is a block diagram illustrating a status and control unit;

FIG. 6 is a flow diagram of another method for monitoring/controlling energy usage;

FIG. 7 is a block diagram illustrating a personal area network (PAN);

FIG. 8 is a block diagram illustrating office scheduler and profiler web services between external scheduler applications and an energy controlling device;

FIG. 9 is a block diagram illustrating analytic web services between an energy manager user interface (UI) and an energy controlling device;

FIG. 10 is a flow diagram of a method for forming a personal area network (PAN); and

FIG. 11 is a block diagram of a device in accordance with one configuration of the described systems and methods.

### DETAILED DESCRIPTION

A method for monitoring and controlling energy usage in an office environment is described. Energy usage information and sensor data are received from a status and control unit for an appliance. An appropriate energy profile for the appliance is determined. The energy profile is customizable by an end user based on preferences and schedules. The energy profile corresponds to appliances within an energy group. A control message is sent to the status and control unit to implement the determined energy profile.

The method may be performed by an energy controlling device. The energy controlling device may include a coordinator and multiple energy profiles. The energy controlling device may also include a mainboard and a daughter board. The daughter board may be a microcontroller. An office scheduler and profiler web service may run on the mainboard. The office scheduler and profiler web service may provide web service access to external applications.

The external applications may include at least one of a browser user interface (UI), a Sharp Open Systems architecture (OSA) application, a personal computer, a multifunction peripheral (MFP) and an energy manager web application. An energy event processing service may run on the mainboard. The energy event processing service may constantly watch for energy events. A status control unit monitor service may run on the daughter board. The status control unit monitor service may monitor a serial port configured for receiving data from the status and control unit. An energy state command and control service may also run on the daughter board. The energy state command and control service may send energy control messages to the status and control unit.

The energy control messages may be sent via an X10 transceiver or via ZigBee. The sensor data may include a radio frequency identification (RFID) message or proximity information. The energy controlling device may communicate with multiple status and control units. The energy controlling device may be one of multiple energy controlling devices interconnected in a cloud server.

The coordinator may start a new Eco Office personal area network (PAN). The PAN may include one or more routers and one or more end devices. Each end device may be in an energy group. An energy profile may correspond to each energy group. An end device may include a status and control unit.

An energy controlling device is also described. The energy controlling device includes a mainboard that includes a processor. The energy controlling device also includes a daughterboard that includes a microcontroller. The energy controlling device further includes memory in electronic communication with the processor. The energy controlling device also includes instructions stored in the memory. The instructions are executable by the processor to receive energy usage information and sensor data from a status and control unit for an appliance. The instructions are also executable by the processor to determine an appropriate energy profile for the appliance. The energy profile is customizable by an end user based on preferences and schedules. The energy profile corresponds to appliances within an energy group. The instructions are further executable by the processor to send a control message to the status and control unit to implement the determined energy profile.

A method for monitoring and controlling energy usage in an office environment is described. Energy usage of an appliance is monitored. Energy usage data is sent to an energy controlling device. Energy control commands are received from the energy controlling device. The energy control commands are the result of executing an energy profile. The energy profile is customizable by an end user based on preferences and schedules. The energy profile corresponds to appliances within an energy group. A power mode state of the appliance is adjusted.

The method may be performed by a status and control unit. The status and control unit may be directly connected to the appliance, integrated with a personal computer or integrated with a multifunction peripheral (MFP). The status and control unit may communicate with the energy controlling device using ZigBee. The status and control unit may monitor energy usage of an appliance using a voltage divider and a current sensing resistor, an infrared (IR) sensor, a light/luminance sensor, and a radio frequency identification (RFID) sensor.

An apparatus is also described. The apparatus includes a microcontroller that includes a processor. The apparatus also includes memory in electronic communication with the processor. The apparatus further includes instructions stored in the memory. The instructions are executable by the processor to monitor energy usage of an appliance. The instructions are also executable by the processor to send energy usage data to an energy controlling device. The instructions are further executable by the processor to receive energy control commands from the energy controlling device. The energy control commands are the result of executing an energy profile. The energy profile is customizable by an end user based on preferences and schedules. The energy profile corresponds to appliances within an energy group. The instructions are also executable to adjust a power mode state of the appliance.

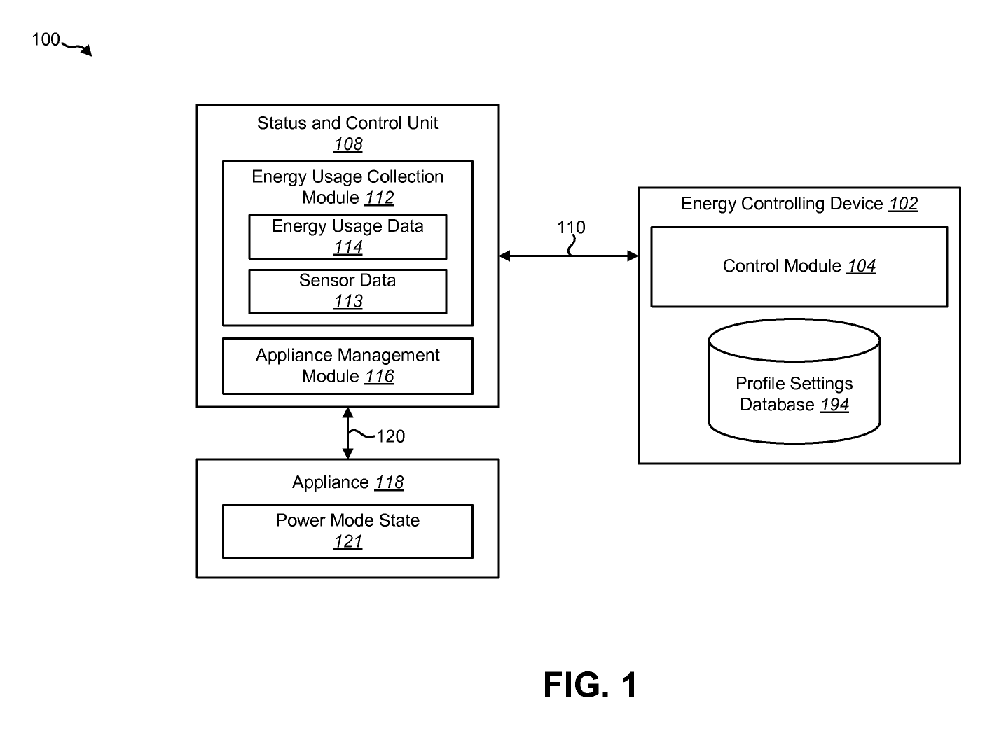

FIG. 1 illustrates an exemplary operating environment 100 in which the disclosed systems and methods for monitoring and controlling energy in an office environment may be utilized. The environment 100 may include an energy controlling device 102, a status and control unit 108 and an appliance 118.

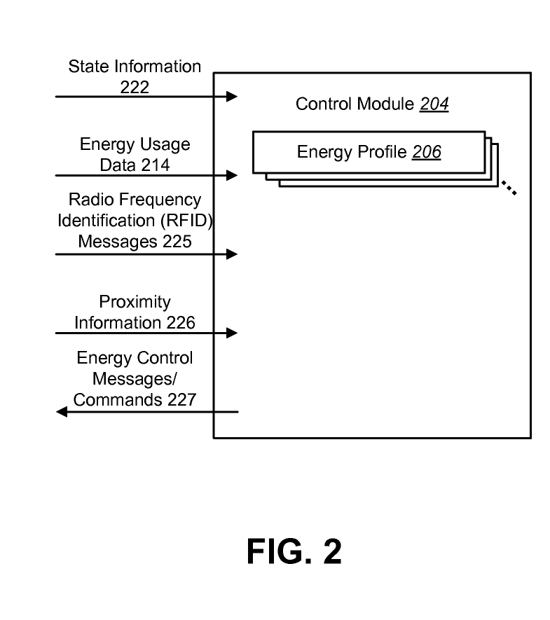

The energy controlling device 102 may be an electronic device for monitoring and controlling the energy usage of one or more appliances 118. Use of the energy controlling device 102 may provide complete control of the operational state (on/off/low power) of one or more appliances 118 as well as monitoring of the energy usage of the appliances 118. Examples of appliances 118 include personal computers, multifunction peripherals (MFPs), lighting devices and heating, ventilating and air conditioning (HVAC) devices. An appliance 118 may have a power mode state 121 (such as turned on, turned off, dimmed, standby, deep sleep and thermostatic reduction). The energy controlling device 102 may allow users to interact with and configure energy usage for their unique office environment. For example, a web portal may allow a user to view summaries and detailed power analytics. These custom user-specific configurations are stored in energy profiles. Energy profiles are discussed in additional detail below in relation to FIG. 2.

The energy controlling device 102 may be a computer. For example, the energy controlling device 102 may be a low-power Linux-based single-board computer such as a “Beagleboard” that is running an embedded Linux operating system (OS). Other operating systems may also be used. This single-board fan-less computer may be connected to a network or the Internet using wired Ethernet or Wi-Fi. A microcontroller daughter board may be connected to the computer via a universal serial bus (USB) interface. The microcontroller daughter board may have input/output (I/O) pins that are used to interface easily with a ZigBee chip.

The energy controlling device 102 may include a control module 104. The control module 104 may be used to monitor and control the energy usage of the appliances 118 via a status and control unit 108. The energy controlling device 102 may also include a profile settings database 194. The profile settings database 194 may include all the energy profile settings.

A building may have multiple energy controlling devices 102 that monitor and control power usage of multiple appliances 118. Multiple energy controlling devices 102 may connect to an Energy Cloud Service (not shown) that monitors energy usage and controls appliances 118 using a secure web service.

A status and control unit 108 may communicate with the energy controlling device 102 via a communication link 110. The communication link 110 may use both wired (e.g., Ethernet, helical local area network (HLAN)) and wireless (e.g., ZigBee, radio frequency identification (RFID)) means. A status and control unit 108 may also communicate directly via a communication link 120 with one or more appliances 118. In one configuration, the status and control unit 108 may be integrated with the appliance 118. For example, the appliance 118 may be a personal computer or a multifunction peripheral (MFP) that has an integrated status and control unit 108.

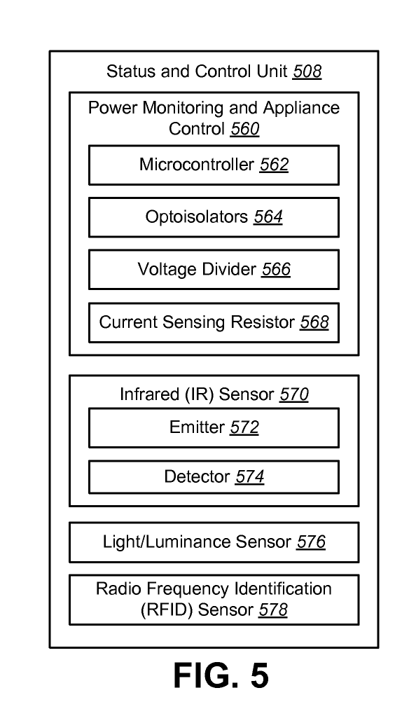

The status and control unit 108 may include an energy usage collection module 112. The energy usage collection module 112 may monitor the energy usage of the appliance 118 and collect energy usage data 114 and sensor data 113. The sensor data 113 may refer to the raw measurements made of energy usage of the appliance 118. The status and control unit 108 may then report the energy usage data 114 and the sensor data 113 to the energy controlling device 102 via the communication link 110. In one configuration, the status and control unit 108 may periodically report the energy usage data 114 and sensor data 113 to the energy controlling device 102. In another configuration, the status and control unit 108 may report the energy usage data 114 and the sensor data 113 to the energy controlling device 102 only when requested to do so by the energy controlling device 102. Status and control units 108 are discussed in further detail below in relation to FIG. 5.

The status and control unit 108 may also include an appliance management module 116. The appliance management module 116 may allow the status and control unit 108 to control the power mode state 121 of an appliance 118. For example, the appliance management module 116 may allow the status and control unit 108 to turn off an appliance 118.

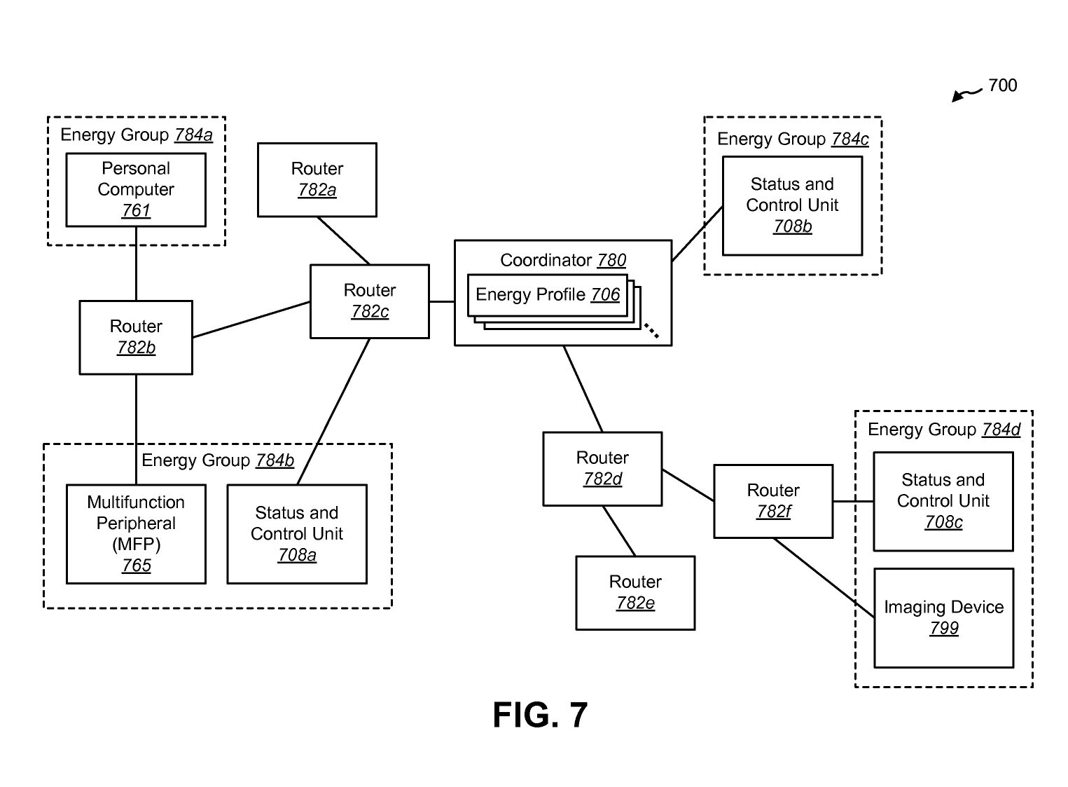

FIG. 2 is a block diagram illustrating a controlling module 204 for use in the present systems and methods. The controlling module 204 of FIG. 2 may be one configuration of the controlling module 104 of FIG. 1. The control module 204 may include one or more energy profiles 206. An energy profile 206 may be a specific energy consumption configuration for a unique office environment. An energy profile 206 may correspond to the energy consumption configuration of a single cubicle, multiple cubicles, a single office or multiple offices. Thus, an energy profile 206 is designed to be scalable such that a tenant in a building can monitor and control power usage for specific areas within the building. Energy profiles 206 applied to different areas is discussed in additional detail below in relation to FIG. 7.

Each energy profile 206 may be customizable for end users based on preferences and schedules. For example, an energy profile 206 may take into account alternate work schedules, differing power consumption in different offices and the specific energy consumption needs of the end users.

The control module 204 may receive state information 222 from one or more status and control units 108. State information 222 may refer to the specific power mode state 121 of an appliance 118 monitored by a status and control unit 108. State information 222 may include an indication that an appliance 118 is operating in high power mode, that an appliance 118 is operating in low power mode or that an appliance 118 is in a standby mode.

The control module 204 may also receive energy usage data 214 from one or more status and control units 108. The energy usage 214 may indicate the amount of electrical power consumed by each appliance 118 associated with the status and control unit 108. The control module 204 may further receive radio frequency identification (RFID) messages 225 from those status and control units 108 that are equipped with radio frequency identification (RFID) sensors. The control module 204 may further receive proximity information 226 from the status and control units 108. The proximity information 226 may include distance information or motion detection information from proximity sensors such as ultrasonic sensors or infrared (IR) sensors. The radio frequency identification (RFID) messages 225 and the proximity information 226 may be sensor data 113 collected by the status and control unit 108.

Based on the received information, the control module 204 may execute energy profiles 206. Executing an energy profile 206 may include sending energy control messages/commands 227 to one or more status and control units 108. An energy control message/command 227 may instruct a status and control unit 108 to change the power mode state 121 of the appliance 118. For example, an energy control message/command 227 may instruct a status and control unit 108 to turn an appliance 118 off, to dim the lights on an appliance 118 or to put an appliance 118 into a deep sleep. The energy control messages/commands 227 may only instruct the status and control unit 108 to change the power mode state 121 of an appliance 118 in ways that are supported by the appliance 118. An energy control message/command 227 may instruct a status and control unit 108 to provide energy usage data 224 and sensor data 113 to the control module 204.

In one configuration, an energy control message/command 227 may be sent to a status and control unit 108 that is integrated with a personal computer. The energy control message/command 227 may instruct the personal computer to go to sleep, hibernate, shut down, reduce clock speed, power down hard drives, etc. In another configuration, an energy control message/command 227 may be sent to a status and control unit 108 that is integrated with a multifunction peripheral (MFP). The energy control message/command 227 may instruct the multifunction peripheral (MFP) to turn off auxiliary functions (such as scanning or the wireless monitoring of networks) or to enter a sleep state (such as turning the fuser off) to power down.

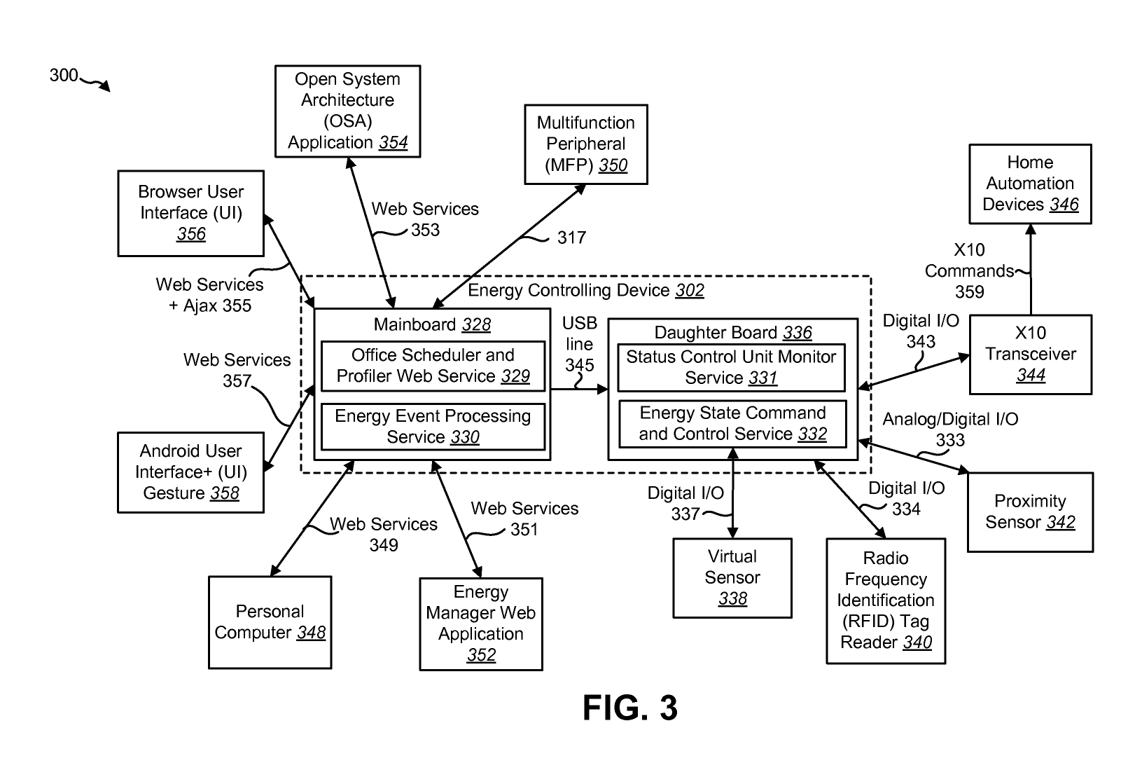

FIG. 3 is a block diagram illustrating an environment 300 in which an energy controlling device 302 may operate. The energy controlling device 302 may communicate wirelessly with one or more status and control units 108 using a low-power ZigBee wireless communication protocol or an Ethernet connection. The status and control units 108 may gather energy usage data 114 from appliances 118 plugged into the status and control units 108. The energy usage data 114 may then be sent to the energy controlling device 302. The status and control units 108 may also receive appliance control commands (i.e., energy control messages/commands 227) from the energy controlling device 302.

A status and control unit 108 may then control the energy state of an appliance 118 using internal solid state relays and circuits. A status and control unit 108 may be equipped with optional interfaces or sensors that monitor proximity, luminance and security tags (i.e., radio frequency identification (RFID)). The data from these sensors may be used to trigger energy events and tools for end-user profiles (i.e., apply a specific energy profile 206 in response to a specific condition detected by a sensor).

The energy controlling device 302 hardware may include an ARM Cortex A8 (32-bit) processor and an AVR Atmega128 (8-bit processor) microcontroller. The ARM Cortex A8 processor may be on the mainboard 328, which runs an embedded version of Linux. The AVR microcontroller may be on a daughter board 336 that has no operating system (OS) and that simply runs the status and control unit monitor service 331 and the energy state command and control service 332. The mainboard 328 may communicate with the daughter board 336 via a USB line 345.

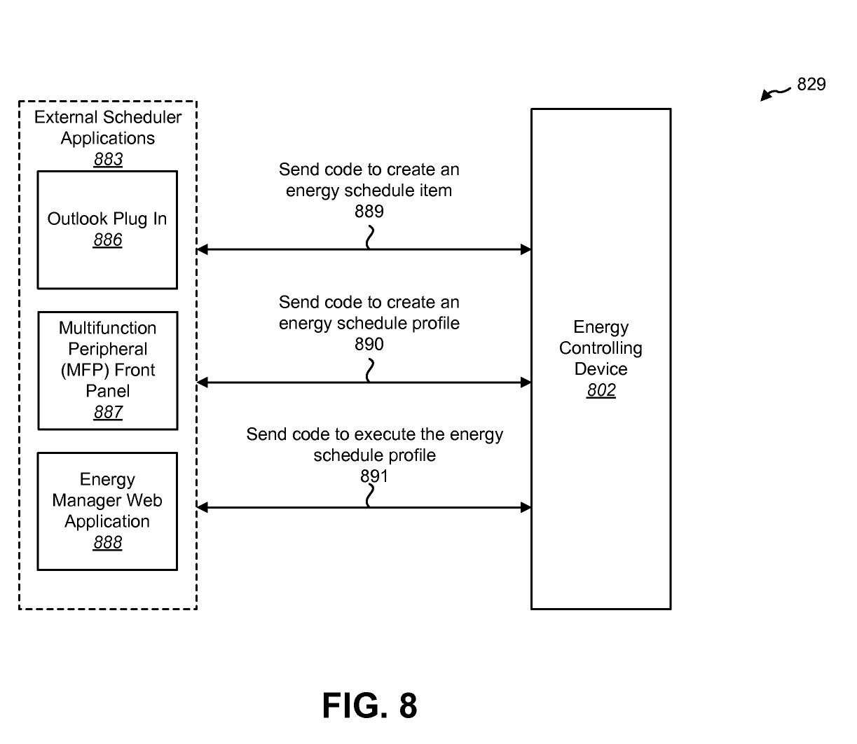

An office scheduler and profiler web service 329 may run on the mainboard 328. The office scheduler and profiler web service 329 may be a set (i.e., an application programming interface (API)) of web service methods. These web service methods may be called by external applications (such as a Sharp Open Systems architecture (OSA) application 354, a browser user interface 356, an Android user interface (UI)+Gesture 358, an energy manager web application 352, a multifunction peripheral (MFP) 350 or a personal computer 348) via web services 317, 349, 351, 353, 355, 357. Android user interface (UI) and Gesture are each an alternate enablement for interacting with the office scheduler and the profiler web services 329. Web service methods that facilitate access to the office scheduler and profiler web services 329 are discussed in additional detail below in relation to FIG. 8.

A windows service may host Representational State Transfer (REST) web services, provide a Structured Query Language (SQL) server database and provide Outlook schedule integration. A windows service is a windows application with no user interface (UI) that runs all the time in the background. A windows service is one way to host the office scheduler and profiler web services 329. REST web services is one way of implementing web services. Both Windows Service and REST web services are technologies that may be used for implementing the methods herein.

An energy event processing service 330 may also run on the mainboard 328. This service may be a Linux daemon (i.e., asynchronous) process that constantly watches for energy events. When an energy event needs to happen (e.g., the user leaves for the day or a profile event gets executed by the web service method call from a mobile device), the energy event processing service 330 may send a Command and Control Message out to the daughter board 336 that includes the appliance ID that needs to be adjusted and an indication of the adjustment (e.g., turn off the power, turn on the power, dim the lights).

The status and control unit monitor service 331 may run on the microcontroller of the daughter board 336 of the energy controlling device 302. The status and control unit monitor service 331 may monitor the serial port that is configured for status and control monitoring (TX0 and RX0 I/O pins by default) and processes data received from all the status and control units 108. The energy usage data 114 and the sensor data 113 may be received by the status and control unit monitor service 331 in an Extensible Markup Language (XML) format.

Below is a sample of a status message (i.e., state information 222) received from a status and control unit 108:

```
  <?xml version=“1.0” encoding=“utf-8”?>
<ecoOfficeStatus>
    <rfid>
        <add key=“scannedID” value=“8397234234” />
      </rfid>
      <proximity>
        <add key=“distanceCM” value=“44” />
      </proximity>
      <luminance >
        <add key=“lux” value=“233” />
      </luminance >
      <voltage>
        <add key=“volts” value=“116.72” />
      </voltage>
      <current>
        <add key=“amps” value=“0.43” />
      </current>
      <frequency>
        <add key=“hz” value=“60.20” />
      </frequency>
      <power>
        <add key=“watts” value=“59.43” />
      </power>
    </ecoOfficeStatus>
```

The following is a sample energy control message/command 227 sent out to a status and control unit 108:

```
<?xml version=“1.0” encoding=“utf-8”?>
<ecoOfficeControl>
  <powerState>
      <add key=“applianceID” value=“A7” />
      <add key=“applianceControlType” value=“X10” />
      <add key=“powerStatus” value=“off” />
    </powerState>
    </ecoOfficeControl>
```

The microcontroller on the daughter board 336 may receive the payload (i.e., energy usage data 114 and sensor data 113) from the status and control units 108 through a wired or wireless connection. In one configuration, the wired connection may be an Ethernet connection and the wireless connection may be ZigBee. The microcontroller on the daughter board 336 may then pre-process the data by adding header and location information to the XML payload. The XML payload is then sent through the second serial port (TX1 and RX1 I/O pins by default) to the mainboard 328.

The microcontroller on the daughter board 336 may also include an energy state command and control service 332. The energy state command and control service 332 may send energy control messages/commands 227 (e.g., turn on/turn off/reduce power) to the status and control units 108. An energy control message/command 227 may include an appliance ID that uniquely identifies the appliance that is plugged into a status and control unit 108. If the status and control unit 108 is configured to use X10, the appliance ID and the energy control messages/commands 227 may be sent to the status and control unit 108 with a type indication that says that the appliance ID is an X10 type. If the appliance ID is an X10 type, the energy state command and control service 332 may construct the bytes for the specific command (the energy control message/command 227) in X10 format (as specified in the X10 protocol documentation) and send that data serially through a digital I/O 343 to the X10 transceiver 344 that is connected to the I/O pins. The X10 transceiver 344 may then send X10 commands 359 to home automation devices 346.

X10 is one way of sending commands. The message and command protocol may also be implemented using a proprietary protocol or implementation. The actual implementation of the messaging protocol is not relevant to the functioning of the system as a whole.

The energy state command and control service 332 may communicate with a proximity sensor 342 via an analog/digital I/O 333. The energy state command and control service 332 may also communicate with a radio frequency identification (RFID) tag reader 340 via a digital I/O 334. Both the proximity sensor 342 and the radio frequency identification (RFID) tag reader 340 may be connected to either the daughter board 336 on the energy controlling device 302 or to the status and control unit 108. There are different ways of implementing the same feature set. If the proximity sensor 342 is connected to the status and control unit 108, then the software piece that will receive the proximity information in the energy controlling device 302 would be a virtual sensor 338 that communicates with the energy state command and control service 332 via a digital I/O 337.

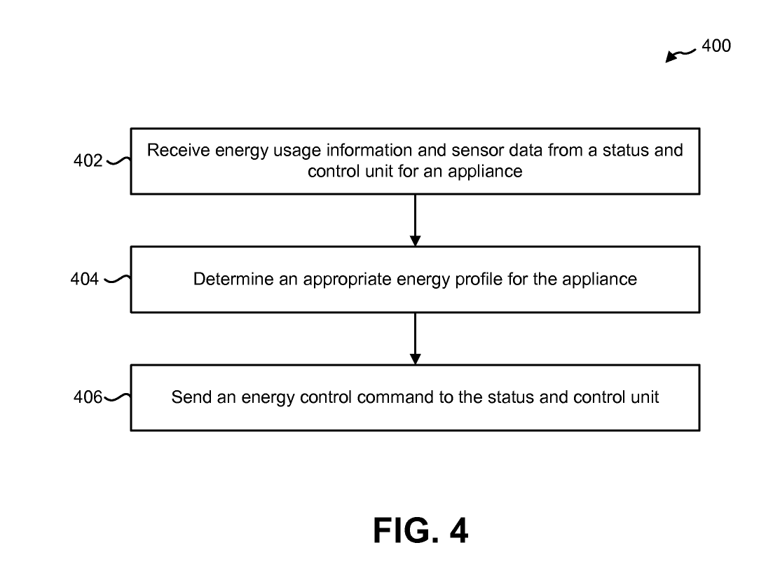

FIG. 4 is a flow diagram of a method 400 for monitoring/controlling energy usage. The method 400 may be performed by an energy controlling device 102. In one configuration, the energy controlling device 102 may be a personal computer. The energy controlling device 102 may receive 402 energy usage data 114 and sensor data 113 from one or more status and control units 108.

The energy usage data 114 may include the power usage of the appliances 118 connected to the status and control units 108. The sensor data 113 may include proximity alerts, luminance alerts and radio frequency identification (RFID) alerts from the status and control units 108 that are equipped with these types of sensors. Based on the sensor data 113 and the energy usage data 114, the energy controlling device 102 may determine 404 an appropriate energy profile 206 for the appliance 118. The energy controlling device 102 may then send 406 an energy control command to the status and control unit 108 communicating with the appliance 118 to turn the appliance 118 on or off. The energy control command may implement the determined energy profile 206. In one configuration, the energy control command may notify the status and control unit 108 to reduce or increase the power consumption of the appliance 118.

FIG. 5 is a block diagram illustrating a status and control unit 508. The status and control unit 508 of FIG. 5 is one configuration of the status and control unit 108 of FIG. 1. A status and control unit 508 may also be referred to as an eco office status and control unit 508. As discussed above, a status and control unit 508 may communicate directly with one or more appliances 118. A status and control unit 508 may also communicate via wired or wireless means with an energy controlling device 102.

The status and control unit 508 may include a power monitoring and appliance control 560. The power monitoring and appliance control 560 may be responsible for turning power on and off in an appliance 118 using a solid relay. In one configuration, the relay may be a RELAY SSR 250VAC 15A from TT Electronics/Optek technology. The power monitoring and appliance control 560 may include a microcontroller 562. By toggling digital I/O pins on the microcontroller 562, the power of an appliance 118 may be turned on or off based on the commands received from an energy controlling device 102. The power monitoring and appliance control 560 may include optoisolators 564 to completely isolate the dangerous high-voltage circuit typically located on an appliance 118 from the microcontroller 562.

The power monitoring may be performed using a voltage divider 566 and a current sensing resistor 568. For voltage monitoring, a very large voltage divider 566 may be used to divide the 170 volts (V) peak-to-peak signal down to a level that can be sampled by the analog-to-digital converter (ADC) I/O pin of the microcontroller 562. To measure current, the neutral line may be broken and a small current-sensing resistor 568 (0.2Ω) may be inserted, thereby creating a small voltage across the current-sensing resistor 568. The current I may then be determined using

$$I = \frac{V}{R} ,$$

where the voltage V and the resistance R are both known. Since the resistance is very small, very little power is dissipated through it.

The status and control unit 508 may also include an infrared (IR) sensor 570. The infrared (IR) sensor 570 may include an emitter 572 and a detector 574. The infrared (IR) sensor 570 may use triangulation to expose distance as an analog-to-digital I/O. In one configuration, the infrared (IR) sensor 570 may be coupled with a Bluetooth signal strength detector (which knows not only that somebody is nearby but also who is nearby through the use of the media access control (MAC) ID) that is running on the energy controlling device 102.

The status and control unit 508 may also include a light/luminance sensor 576. The light/luminance sensor 576 may be a TSL230R light sensor. The light/luminance sensor 576 may convert irradiance into frequency. The light/luminance sensor 576 may have a pulse train and a square wave. The microcontroller 562 may register an interrupt to count the high pulses; the lux values (lumens per square meter) may be computed every second by the microcontroller 562. The data returned by the light/luminance sensor 576 may be read in through the five digital I/O pins on the microcontroller 562.

In one configuration, the lux values at a particular area may be sent to the energy controlling device 102. The energy controlling device 102 may use this information along with other information available to the energy controlling device 102 (e.g., the profile settings for a particular office or time of day) to manage energy consumption. For example, the energy controlling device 102 may dim LED lights to save energy.

The status and control unit 508 may also include a radio frequency identification (RFID) sensor 578. In one configuration, a Wiegand protocol may be used to read in radio frequency identification (RFID) values from the radio frequency identification (RFID) sensor 578 that is attached to the microcontroller 562. The Wiegand protocol is commonly used in office access control systems and is the de facto wiring standard used in the industry. The radio frequency identification (RFID) sensor 578 may use two digital I/O pins. Once the status and control unit 508 detects a radio frequency identification (RFID) scan, the status and control unit 508 may read the value from the pins and then send this sensor data 113 to the energy controlling device 102 for authentication and validation. The energy controlling device 102 may check the profile settings database 194 and the profile settings that are stored in the profile settings database 194 to execute a specific profile.

As discussed above, the status and control unit 508 may not have an operating system (OS). Instead, the status and control unit 508 may have one service (i.e., one power monitoring and appliance control) that is always running when the status and control unit 508 is powered on. The service may monitor all the digital and analog I/O pins where sensors are attached for any sensor events (e.g., radio frequency identification (RFID) scan, proximity detection, measured lux above a certain threshold).

The service may also monitor for events (through interrupts) on the ZigBee pins (exposed as a universal asynchronous receiver/transmitter (UART)) or transmission control protocol (TCP) integrated circuit (IC) pins (also exposed as UART) for any control messages from the energy controlling device 102. If the status and control unit 508 is configured for energy monitoring, the status and control unit 508 may sample the analog I/O pins and send computed current and voltage measurements to the energy controlling device 102.

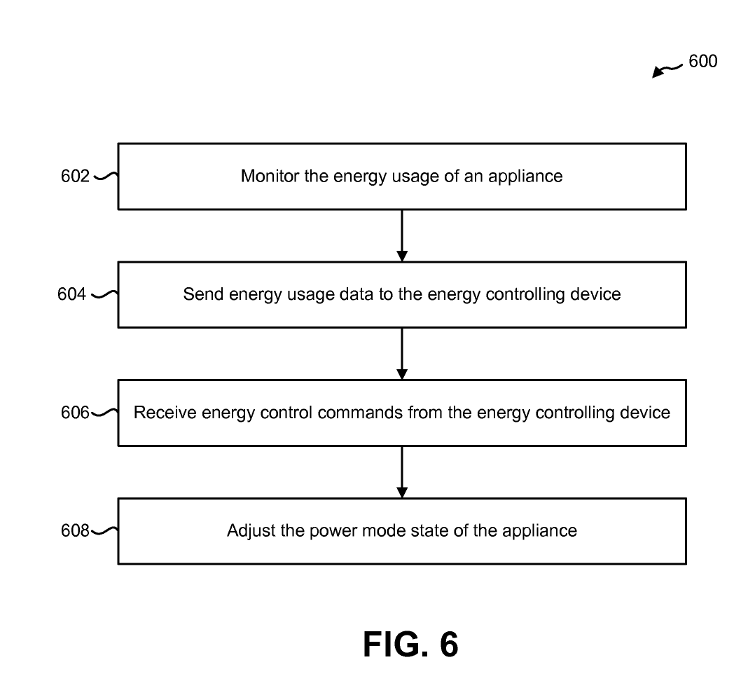

FIG. 6 is a flow diagram of another method 600 for monitoring/controlling energy usage. The method 600 may be performed by a status and control unit 508. The status and control unit 508 may be directly connected to an appliance 118. In one configuration, the status and control unit 508 may be integrated within an appliance 118.

The status and control unit 508 may monitor 602 the energy usage of an appliance 118. In one configuration, the status and control unit 508 may monitor 602 the energy usage of an appliance 118 using a voltage divider 566 and a current sensing resistor 568, an infrared (IR) sensor 570, a light/luminance sensor 576 or a radio frequency identification (RFID) sensor 578. Monitoring 602 the energy usage of an appliance 118 may include receiving proximity alerts, luminance alerts and radio frequency identification (RFID) alerts by those status and control units 508 that are equipped with these types of sensors. Monitoring 602 the energy usage of an appliance 118 may include obtaining energy usage data 114. A status and control unit 508 may continuously monitor 602 the energy usage of the appliances 118 that are connected to it.

The status and control unit 508 may then send 604 the energy usage data 114 to the energy controlling device 102. In one configuration, the status and control unit 508 may send the energy usage data 114 to the energy controlling device 102 using a ZigBee protocol. In another configuration, the status and control unit 508 may send the energy usage data 114 to the energy controlling device 102 using wired means (e.g., Ethernet).

The status and control unit 508 may receive 606 energy control commands from the energy controlling device 102. The energy control commands may be received in response to the sending 604 of energy usage data 114. The energy usage data 114 may be analyzed by the energy controlling device 102 to assist a user in the creation of energy profiles in the energy profiles database 194. Both the energy usage data 114 and the energy profiles 206 are stored in the energy profiles database 194. The status and control unit 508 may receive 606 energy control commands via wired or wireless means (e.g., using a ZigBee protocol, Ethernet). Energy control commands may include commands to turn the power off on an appliance 118, commands to turn the power on of an appliance 118, commands to dim the lights on an appliance 118, etc. Energy control commands may be the result of executing an energy profile 206.

The status and control unit 508 may then adjust 608 the power mode state 121 of the appliance 118 based on the received energy control commands. Adjusting 608 the power mode state of an appliance 118 may include executing an energy profile 206 for the appliance 118. By toggling I/O pins on the microcontroller 562, the status and control unit 508 may execute energy profiles 206 for an appliance 118.

FIG. 7 is a block diagram illustrating a personal area network (PAN) 700. A personal area network (PAN) 700 may be a ZigBee personal area network (PAN) 700. As discussed above, the communication link 110 between a status and control unit 708 and an energy controlling device 102 may be ZigBee. In one configuration, the communication link 110 between a status and control unit 708 and the energy controlling device 102 may instead be Transmission Control Protocol (TCP) if the status and control units 108 and the energy controlling device 102 daughter board 336 are equipped with a TCP controller integrated circuit (IC) and an RJ-45 jack.

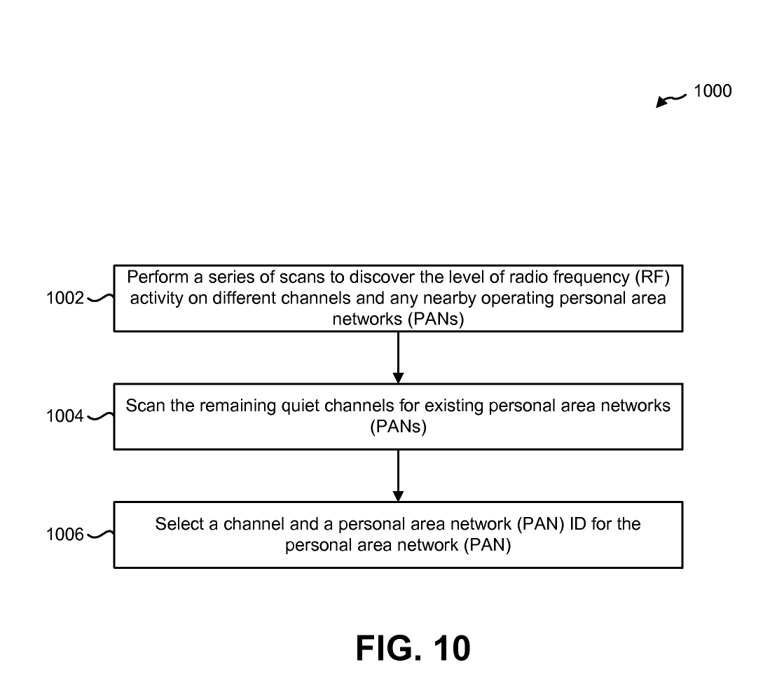

Each personal area network (PAN) 700 may include one coordinator 780. The coordinator may also be referred to as an Eco coordinator 780. The coordinator 780 may be responsible for selecting the channel and an Eco Office PAN ID (a 16-bit value that uniquely identifies a personal area network (PAN) 700). There may be one network with a unique Eco Office PAN ID per office area. Multiple cubicles may be managed by a single coordinator 780. In one configuration, the coordinator 780 may be on the daughter board 336 of the energy controlling device 102. Forming a personal area network (PAN) is discussed in additional detail below in relation to FIG. 10.

The coordinator 780 may start a new Eco Office personal area network (PAN) 700. Once the coordinator 780 has started a new Eco Office personal area network (PAN) 700, the coordinator 780 can allow routers 782a-f and end devices (e.g., personal computers 761, multifunction peripherals (MFPs) 765, imaging devices 799 and status and control units 708a-c) to join the Eco Office personal area network (PAN) 700. The coordinator 780 may transmit and receive radio frequency (RF) data transmissions and can thus assist in routing data through the mesh network. Since the coordinator 780 must be able to allow joins and/or route data, it should be mains powered instead of being a battery-powered device.

Any status and control unit 708 can act as a router 782. After joining the personal area network (PAN) 700, the router 782 may allow other routers 782 and end devices to join the personal area network (PAN) 700. A router 782 can transmit and receive radio frequency (RF) data transmissions and is thus capable of routing data packets through the personal area network (PAN) 700.

An end device may be part of an energy group 784a-d. For example, the personal computer 761 may be part of a first energy group 784a, the multifunction peripheral (MFP) 765 and a first status and control unit 708a may be part of a second energy group 784b, a second status and control unit 708b may be part of a third energy group 784c and a third status and control unit 708c and an imaging device 799 may be part of a fourth energy group 784d. Each energy group 784 may have one or more associated energy profiles 706 on the coordinator 780. The coordinator 780 may thus apply an energy profile 706 for all end devices within an energy group 784. An energy group 784 is a logical grouping of end devices but may represent a physical area such as a cubicle or an office. An energy group 784 may be configurable by an end user.

A group of coordinators 780 (each coordinator 780 being part of an energy controlling device 102) may produce a scalable energy management architecture for energy management of a building. The scalable energy management architecture may include multiple status and control units 708 and other end devices connected to each energy controlling device 102; the energy controlling devices 102 may be connected (as an aggregation of multiple locations) in a cloud server.

FIG. 8 is a block diagram illustrating office scheduler and profiler web services 829 between external scheduler applications 883 and an energy controlling device 802. The scheduling functionality on the energy controlling device 802 may be either programmatic (e.g., Web service based) or user interface (UI) based (e.g., an energy manager web application). Office scheduler and profile web services 329 are a set (i.e., an application programming interface (API)) of web service methods that run on the mainboard 328 and are hosted by a web server such as Apache. These web service methods may be called by external applications 883 (e.g., an Outlook plug-in 886, a multifunction peripheral (MFP) front panel 887, an energy manager web application 888, open source architecture (OSA) applications 354 (other external applications 883 may also be used)) to create energy profiles 206, process/execute profiles and schedule energy events.

For example, a web service may facilitate access to the scheduling and profiling web service methods by sending 889 code to create an energy schedule item (e.g., CreateEnergyScheduleItem (energyScheduleName, pcIPAddress, startTime, endTime, energyState), sending 890 code to create an energy schedule profile (e.g., CreateEnergyScheduledProfile (energyProfileScheduleName, pcIPAddress, startTime, endTime, energyState, profileType) or sending 891 code to execute the energy scheduling profile (e.g., ExecuteProfile (profileType, pcIPAddress)) to the energy controller 802.

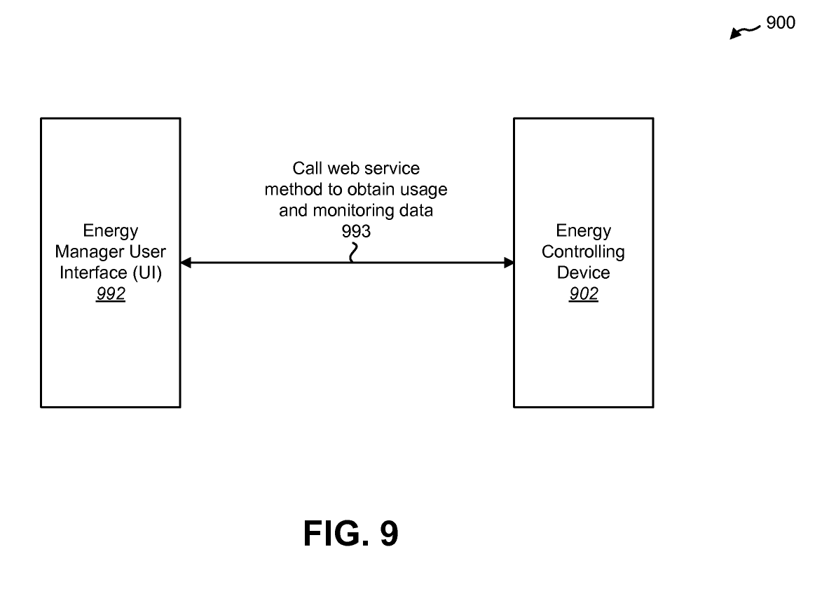

FIG. 9 is a block diagram illustrating analytic web services 900 between an energy manager user interface (UI) 992 and an energy controlling device 902. Analytic web services 900 are a set (i.e., an API) of web service methods that are accessed by external personal computer based applications (via an energy manager user interface (UI) 992) to get usage and monitoring data from a controller database on the energy controlling device 902. For example, a web service method to obtain usage and monitoring data may be called 993 (e.g., GetArms (int applianceID, dateTime StartTime, dateTime EndTime)) by the energy manager user interface (UI) 992 through Ajax to retrieve the current usage of a particular appliance 118 and render a chart to be displayed on a web page.

FIG. 10 is a flow diagram of a method 1000 for forming a personal area network (PAN) 700. The personal area network (PAN) 700 may be formed using ZigBee. The method 1000 may be performed by a coordinator 780.

The coordinator 780 may perform 1002 a series of scans to discover the level of radio frequency (RF) activity on different channels (energy scan) and to discover any nearby operating personal area networks (PANs) (this may be referred to as a PAN scan, an active scan or a beacon scan). An energy scan may occur when a controller 782 comes up for the first time. The coordinator 780 may perform 1002 an energy scan on multiple channels (frequencies) to detect energy levels on each channel. Channels with excessive detected energy levels may be removed from a list of potential channels for the coordinator 780 to start on.

When the series of scans has completed, the coordinator 780 may scan 1004 the remaining quiet channels (channels found in the series of scans) for existing personal area networks (PANs). To do this, the coordinator 780 may send a broadcast, one-hop beacon request. Any nearby eco office coordinators 780 and routers 782 will respond to the beacon request by sending a beacon frame back to the eco coordinator 780. The beacon frame may include information about the personal area network (PAN) the sender is on, including the PAN ID and whether or not the device is allowing other devices to join the personal area network (PAN).

The coordinator 780 may then select 1006 a channel and a personal area network (PAN) ID for the personal area network (PAN) 700. After the coordinator 780 has started the personal area network (PAN) 780, routers 782 and end devices (such as personal computers 761, multifunction peripherals (MFPs) 765, imaging devices 799 and status and control units 708) may join the personal area network (PAN) 700.

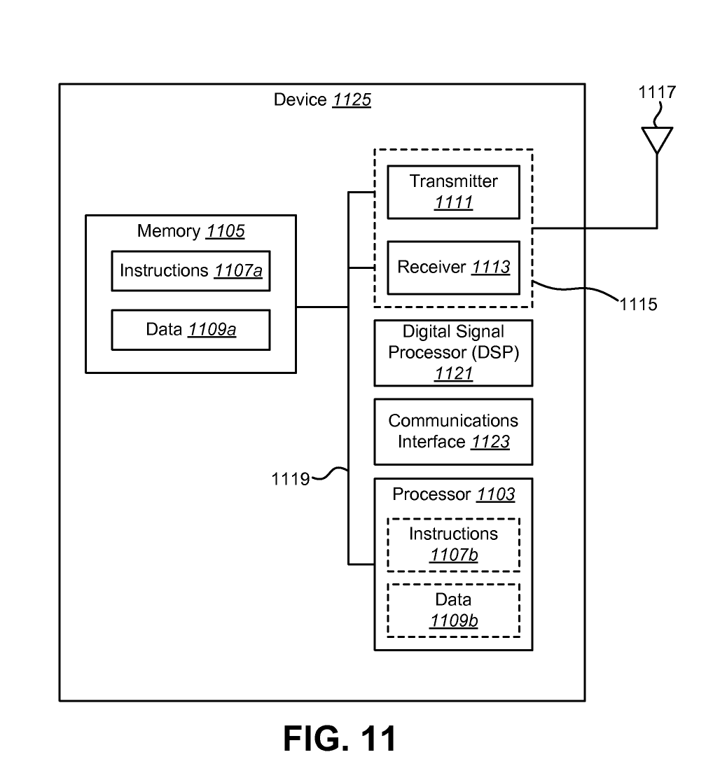

FIG. 11 is a block diagram of a device 1125 in accordance with one configuration of the described systems and methods. The device 1125 may be an energy controlling device 102. The device 1125 may also be a status and control unit 108. In one configuration, the device 1125 may be a personal computer 761 or a multifunction peripheral (MFP) 765. The device 1125 may include a transceiver 1115 that includes a transmitter 1111 and a receiver 1113. The transceiver 1115 may be coupled to one or more antennas 1117. The device 1125 may further include a digital signal processor (DSP) 1121, a general purpose processor 1103, memory 1105 and a communications interface 1123. The various components of the device 1125 may be included within a housing.

The processor 1103 may control operation of the device 1125. The processor 1103 may also be referred to as a central processing unit (CPU). The memory 1105, which may include both read-only memory (ROM) and random access memory (RAM), provides instructions 1107a and data 1109a to the processor 1103. A portion of the memory 1105 may also include non-volatile random access memory (NVRAM). The memory 1105 may include any electronic component capable of storing electronic information, and may be embodied as ROM, RAM, magnetic disk storage media, optical storage media, flash memory, on-board memory included with the processor 1103, EPROM memory, EEPROM memory, registers, a hard disk, a removable disk, a CD-ROM, etc.

The memory 1105 may store program instructions 1107a and other types of data 1109a. The program instructions 1107a may be executed by the processor 1103 to implement some or all of the methods disclosed herein. The processor 1103 may also use the data 1109a stored in the memory 1105 to implement some or all of the methods disclosed herein. As a result, instructions 1107b and data 1109b may be loaded and/or otherwise used by the processor 1103.

In accordance with the disclosed systems and methods, the antenna 1117 may receive signals that have been transmitted from a nearby communications device, such as an energy controlling device 102 or a status and control unit 108. The antenna 1117 provides these received signals to the transceiver 1115, which filters and amplifies the signals. The signals are provided from the transceiver 1115 to the DSP 1121 and to the general purpose processor 1103 for demodulation, decoding, further filtering, etc.

The various components of the device 1125 are coupled together by a bus system 1119, which may include a power bus, a control signal bus, and a status signal bus in addition to a data bus. However, for the sake of clarity, the various busses are illustrated in FIG. 11 as the bus system 1119.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for monitoring and controlling energy usage in an office environment, comprising:
receiving energy usage information and sensor data from a status and control unit for an appliance;
determining an appropriate energy profile for the appliance, wherein the energy profile is customizable by an end user based on preferences and schedules, and wherein the energy profile corresponds to appliances within an energy group; and
sending a control message to the status and control unit to implement the determined energy profile.

2. The method of claim 1, wherein the method is performed by an energy controlling device.

3. The method of claim 1, wherein the energy controlling device comprises a coordinator and multiple energy profiles.

4. The method of claim 1, wherein the energy controlling device comprises a mainboard and a daughter board, wherein the daughter board comprises a microcontroller.

5. The method of claim 4, wherein an office scheduler and profiler web service runs on the mainboard, and wherein the office scheduler and profiler web service provides web service access to external applications.

6. The method of claim 5, wherein the external applications comprise at least one of a browser user interface (UI), a Sharp Open Systems architecture (OSA) application, a personal computer, a multifunction peripheral (MFP) and an energy manager web application.

7. The method of claim 5, wherein an energy event processing service runs on the mainboard, and wherein the energy event processing service constantly watches for energy events.

8. The method of claim 5, wherein a status control unit monitor service runs on the daughter board, and wherein the status control unit monitor service monitors a serial port configured for receiving data from the status and control unit.

9. The method of claim 5, wherein an energy state command and control service runs on the daughter board, and wherein the energy state command and control service sends energy control messages to the status and control unit.

10. The method of claim 9, wherein the energy control messages are sent via an X10 transceiver.

11. The method of claim 9, wherein the energy control messages are sent via ZigBee.

12. The method of claim 1, wherein the sensor data comprises a radio frequency identification (RFID) message.

13. The method of claim 1, wherein the sensor data comprises proximity information.

14. The method of claim 2, wherein the energy controlling device communicates with multiple status and control units, and wherein the energy controlling device is one of multiple energy controlling devices interconnected in a cloud server.

15. The method of claim 3, wherein the coordinator starts a new Eco Office personal area network (PAN).

16. The method of claim 15, wherein the PAN comprises one or more routers and one or more end devices, wherein each end device is in an energy group, and wherein an energy profile corresponds to each energy group.

17. The method of claim 16, wherein an end device comprises a status and control unit.

18. An energy controlling device, comprising:
a mainboard, wherein the mainboard comprises a processor;
a daughterboard, wherein the daughterboard comprises a microcontroller;
memory in electronic communication with the processor;
instructions stored in the memory, the instructions being executable to:
receive energy usage information and sensor data from a status and control unit for an appliance;
determine an appropriate energy profile for the appliance, wherein the energy profile is customizable by an end user based on preferences and schedules, and wherein the energy profile corresponds to appliances within an energy group; and
send a control message to the status and control unit to implement the determined energy profile.

19. The energy controlling device of claim 18, wherein the energy controlling device further comprises a coordinator and multiple energy profiles.

20. The energy controlling device of claim 18, wherein an office scheduler and profiler web service runs on the mainboard, and wherein the office scheduler and profiler web service provides web service access to external applications.

21. The energy controlling device of claim 20, wherein the external applications comprise at least one of a browser user interface (UI), a Sharp Open Systems architecture (OSA) application, a personal computer, a multifunction peripheral (MFP) and an energy manager web application.

22. The energy controlling device of claim 20, wherein an energy event processing service runs on the mainboard, and wherein the energy event processing service constantly watches for energy events.

23. The energy controlling device of claim 20, wherein a status control unit monitor service runs on the daughter board, and wherein the status control unit monitor service monitors a serial port configured for receiving data from the status and control unit.

24. The energy controlling device of claim 20, wherein an energy state command and control service runs on the daughter board, and wherein the energy state command and control service sends energy control messages to the status and control unit.

25. The energy controlling device of claim 24, wherein the energy control messages are sent via an X10 transceiver.

26. The energy controlling device of claim 24, wherein the energy control messages are sent via ZigBee.

27. The energy controlling device of claim 18, wherein the sensor data comprises a radio frequency identification (RFID) message.

28. The energy controlling device of claim 18, wherein the sensor data comprises proximity information.

29. The energy controlling device of claim 18, wherein the energy controlling device communicates with multiple status and control units, and wherein the energy controlling device is one of multiple energy controlling devices interconnected in a cloud server.

30. The energy controlling device of claim 19, wherein the coordinator starts a new Eco Office personal area network (PAN).

31. The energy controlling device of claim 30, wherein the PAN comprises one or more routers and one or more end devices, wherein each end device is in an energy group, and wherein an energy profile corresponds to each energy group.

32. The energy controlling device of claim 31, wherein an end device comprises a status and control unit.

33. A method for monitoring and controlling energy usage in an office environment, comprising:
monitoring energy usage of an appliance;
sending energy usage data to an energy controlling device;
receiving energy control commands from the energy controlling device, wherein the energy control commands are the result of executing an energy profile, wherein the energy profile is customizable by an end user based on preferences and schedules, and wherein the energy profile corresponds to appliances within an energy group; and
adjusting a power mode state of the appliance.

34. The method of claim 33, wherein the method is performed by a status and control unit.

35. The method of claim 34, wherein the status and control unit is directly connected to the appliance.

36. The method of claim 34, wherein the status and control unit is integrated with a personal computer.

37. The method of claim 34, wherein the status and control unit is integrated with a multifunction peripheral (MFP).

38. The method of claim 34, wherein the status and control unit communicates with the energy controlling device using ZigBee.

39. The method of claim 34, wherein the status and control unit monitors energy usage of an appliance using a voltage divider and a current sensing resistor.

40. The method of claim 34, wherein the status and control unit monitors energy usage using an infrared (IR) sensor, a light/luminance sensor, and a radio frequency identification (RFID) sensor.

41. An apparatus, comprising:
a microcontroller comprising a processor;
memory in electronic communication with the processor;
instructions stored in the memory, the instructions being executable to:
monitor energy usage of an appliance;
send energy usage data to an energy controlling device;
receive energy control commands from the energy controlling device, wherein the energy control commands are the result of executing an energy profile, wherein the energy profile is customizable by an end user based on preferences and schedules, and wherein the energy profile corresponds to appliances within an energy group; and
adjust a power mode state of the appliance.

42. The apparatus of claim 41, wherein the apparatus is a status and control unit.

43. The apparatus of claim 42, wherein the status and control unit is directly connected to the appliance.

44. The apparatus of claim 42, wherein the status and control unit is integrated with a personal computer.

45. The apparatus of claim 42, wherein the status and control unit is integrated with a multifunction peripheral (MFP).

46. The apparatus of claim 42, wherein the status and control unit communicates with the energy controlling device using ZigBee.

47. The apparatus of claim 42, further comprising a voltage divider and a current sensing resistor, wherein the status and control unit monitors energy usage of an appliance using the voltage divider and the current sensing resistor.

48. The apparatus of claim 42, further comprising:
an infrared (IR) sensor;
a light/luminance sensor; and
a radio frequency identification (RFID) sensor.
